(19) United States
(12) Patent Application Publication
(10) Pub. No.: US 2005/0137281 A1
(43) Pub. Date: Jun. 23, 2005

(54) Printable dielectric materials, devices, and methods

(75) Inventors: Jessica L. Voss-Kehl, Inver Grove Heights, MN (US); Feng Bai, Woodbury, MN (US); Tzu-Chen Lee, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/740,301

(22) Filed: Dec. 18, 2003

(51) Int. Cl. B05D 1/36; C08K 3/10; C03C 17/00

(52) U.S. Cl. 523/160; 427/258; 524/413

(57) ABSTRACT

Inkjet printable compositions containing styrenic polymers, typically cyano-functional styrenic polymers, with relatively high dielectric constants k, along with additional optional ingredients, such as inorganic particles are disclosed. The compositions typically can be printed using an inkjet printer.

### BACKGROUND

Dielectric materials are used in a wide variety of electronic devices. Examples include transistors, diodes, capacitors (e.g., embedded capacitors), and resistors, which can be used in various arrays to form amplifiers, receivers, transmitters, inverters, and oscillators, for example. Dielectric materials used in these and other devices are often deposited in complex patterns during manufacture of the electronic devices.

As electronic devices have decreased in size, a need to create smaller dielectric patterns has emerged, especially thinner dielectric patterns. These smaller, thinner dielectric patterns require a material with a high dielectric constant k. In addition, a need for the ability to easily change dielectric patterns and to customize dielectric patterns has emerged. This need has been driven, in part, by increasing customization of electronic devices, the need for functional prototypes, and a demand for short product development cycles.

Therefore, a need exists for dielectric materials that can be deposited in complex, minute patterns; and a need exists for dielectric materials that can be economically deposited in readily customized patterns.

### SUMMARY

The present invention provides a composition having a high dielectric constant and that can be printed with an inkjet printer, methods of printing the composition, and articles made using the composition.

In certain embodiments, the invention includes a composition containing a liquid delivery medium and a polymer having at least two monomeric units corresponding, respectively, to the formulae: 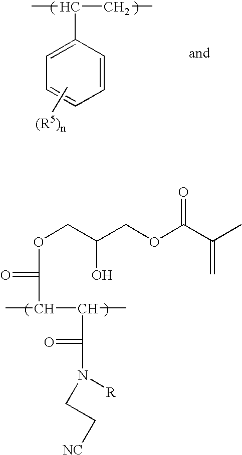
wherein R is CH₃ or CH₂CH₂CN; each R⁵ is independently an alkyl group, a halogen, or an organic group comprising at least one CN group and having a molecular weight of about 30 to about 200 per CN group; and n=0-3. In addition, the composition may contain inorganic particles, for example, barium titanate particles. The composition including the polymer and particles generally has a viscosity prior to curing such that is printable using an inkjet printer.

In some embodiments, the invention includes a composition containing a liquid delivery medium and a polymer having at least two monomeric units corresponding, respectively, to the formulae: 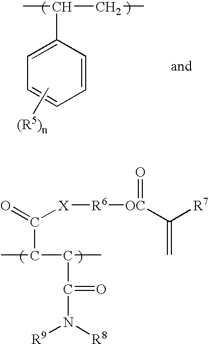
wherein X represents O, S, or NR¹⁰, wherein R¹⁰ represents H or a C₁-C₂ alkyl group; R⁶ represents a C₁-C₅ alkylene group, optionally substituted with at least one hydroxyl group; R⁷ represents H or CH₃; R⁸ represents an C₁-C₆ alkyl group or an organic group comprising at least one CN group and having a molecular weight of about 30 to about 200 per CN group; and R⁹ represents an organic group comprising at least one CN group and having a molecular weight of about 30 to about 200 per CN group.

Various features and advantages of the invention will be apparent from the following detailed description of the invention and the claims. The above summary is not intended to describe each illustrated embodiment or every embodiment of the present disclosure. The detailed description that follows more particularly exemplifies certain preferred embodiments utilizing the principles disclosed herein.

### DETAILED DESCRIPTION

Printable compositions of the present invention include styrenic polymers, typically cyano-functional styrenic polymers, with relatively high dielectric constants k, and a liquid delivery medium, along with additional optional ingredients, such as inorganic particles.

The compositions typically can be printed using an inkjet printer. The polymer materials used for the composition, suitable particles, and methods of printing the compositions will now be described in greater detail.

As used herein, a “polymer” includes two or more monomeric units (e.g., homopolymers and copolymers), and a “copolymer” includes two or more different monomeric units, and encompasses terpolymers, tetrapolymers, etc. The copolymers can be random, block, alternating, etc.

As used herein, “a” or “an” or “the” are used interchangeably with “at least one” to mean “one or more” of the element being modified.

As used herein, the term “organic group” means a hydrocarbon group (with optional elements other than carbon and hydrogen, such as oxygen, nitrogen, sulfur, silicon, and halogens) that is classified as an aliphatic group, cyclic group, or combination of aliphatic and cyclic groups (e.g., alkaryl and aralkyl groups). In the context of the present invention, the organic groups are those that do not interfere with the film-forming properties of the organic dielectric layer and/or the formation or function of a semiconductor layer adjacent to the organic dielectric layer. The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, hexyl, heptyl, dodecyl, octadecyl, amyl, 2-ethylhexyl, and the like. The term ‘alkenyl group’ means an unsaturated linear or branched hydrocarbon group with one or more carbon-carbon double bonds, such as a vinyl group. The term “alkynyl group” means an unsaturated linear or branched hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group, including within its scope alkaryl and aralkyl groups. The term “heterocyclic group” means a closed ring hydrocarbon in which one or more of the atoms in the ring is an element other than carbon (e.g., nitrogen, oxygen, sulfur, etc.).

Substitution is anticipated on the organic groups of the polymers of the present invention. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

As used herein, “layer” refers to any layer that can be formed on a substrate from precursor compounds using a solution coating process or vapor deposition process, for example. The term “layer” is meant to include layers specific to the semiconductor industry, such as “barrier layer,” “dielectric layer,” “insulating layer,” and “conductive layer.” (The term “layer” is synonymous with the term “film” frequently used in the semiconductor industry.) A layer can include continuous and discontinuous patterns. The term “layer” is also meant to include layers found in technology outside of semiconductor technology, such as coatings on glass.

Polymer Material

Inkjet printable compositions of the present invention include styrenic polymers, typically cyano-functional styrenic polymers, with relatively high dielectric constants. These polymers can be prepared by standard chemical techniques (e.g., free radical polymerization from the corresponding monomers or chemical modifications of existing polymers).

Suitable polymers for use in forming the printable compositions include polymers having a cyano-functional portion and a portion that provides a relatively high dielectric constant to the overall polymer, which portions may be the same or different. The polymers can be homopolymers or copolymers. Copolymers are those polymers prepared from two or more different monomers and include terpolymers, tetrapolymers, and the like. The monomers can join to form random, block, segmented copolymers, as well as any of a variety of other structural arrangements.

If inorganic particles are including in the printable compositions the amount of polymer in the printable composition is typically in a range of from at least 5, 10, 20, 30 or 40 percent up to and including 50, 80, or even 95 percent by weight, based on the total weight of the polymer and inorganic particles, although higher and lower amounts may also be used.

In one embodiment, the polymer includes a substantially nonfluorinated organic polymer having at least two monomeric units corresponding, respectively, to the formulae: 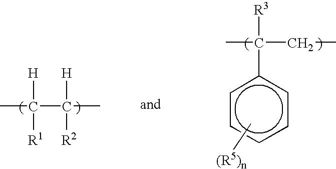
wherein: each R¹ is independently H, an aryl group (including aralkyl and alkaryl), Cl, Br, I, or an organic group that includes a crosslinkable group (i.e., one or more crosslinkable groups); each R² is independently H, an aryl group (including aralkyl and alkaryl), or R⁴; each R³ is independently H or methyl; each R⁵ is a substituent on the aromatic ring and is independently an alkyl group, a halogen, or R⁴; n=0-3; and each R⁴ is independently an organic group that includes at least one CN group and has a molecular weight of about 30 to about 200 per CN group; with the proviso that at least one monomeric unit in the polymer includes an R⁴. Preferably, at least one R¹ includes a crosslinkable group. For certain embodiments, the substantially nonfluorinated dielectric polymer is crosslinked.

In another embodiment, the present invention provides an electronic device that includes a dielectric layer that includes an organic polymer (preferably, a substantially nonfluorinated organic polymer) having monomeric units wherein: each R¹ is independently an organic group that includes a crosslinkable group (i.e., one or more crosslinkable groups); each R² is independently H, an aryl group (including alkaryl and aralkyl), or R⁴; each R³ is independently H or methyl; each R⁵ is a substituent on the aromatic ring and is independently an alkyl group, a halogen, or R⁴; n=0-3; and each R⁴ is independently an organic group that includes at least one CN group and has a molecular weight of about 30 to about 200 per CN group; with the proviso that at least one monomeric unit in the polymer includes an R⁴. The two monomeric units could be the same, thereby forming a homopolymer. Crosslinkable polymers are particularly desirable because they provide flexibility in manufacturing methods, easily integrate with solution processed device layers.

For certain embodiments, the polymers are crosslinked. Crosslinked polymers typically tolerate higher breakdown field strengths than their uncrosslinked analogs. Also, there is typically a difference in dielectric constants of crosslinked and uncrosslinked polymers. The polymers can be substantially nonfluorinated. Herein, “substantially nonfluorinated” means that less than about 5 percent (more preferably less than about 1 percent and even more preferably 0 percent) of the carbons in the polymeric layer have fluorine substituents. Thus, certain polymers can have a small amount of fluorine (e.g., in R⁵).

For certain embodiments, at least one R¹ includes at least one crosslinkable group. Examples of crosslinkable groups include, for example, (meth)acrylates (i.e., acrylates and methacrylates), amines, hydroxyls, thiols, oxiranes, aziridines, chlorosilanes (e.g., trialkoxysilanes), vinyls, and alkoxysilanes (e.g., trialkoxysilanes). Preferably, the crosslinkable groups are acrylates. Combinations of various crosslinkable groups can be within any one polymer. The crosslinkable groups are typically incorporated into an organic group, which can be up to about 20 carbon atoms in size. In addition, the crosslinkable groups can contain heteroatoms such as O, N, S, P, and Si.

For certain embodiments, R¹ and R² include aryl groups that can include up to 18 carbon atoms in size. Preferably, the aryl groups for R¹ and R² are (C₅-C₈) aryl groups, examples of which include, but are not limited to, phenyl, naphthyl, phenanthryl, anthracenyl, or alkyl-substituted derivatives thereof. Preferred aryl groups for R¹ and R² include phenyl. These groups may be substituted with one to three R⁵ groups.

For certain embodiments, R⁵ can be a (C₁-C₂₀) alkyl group, more preferably a (C₁-C₁₂) alkyl group, even more preferably a (C₁-C₈) alkyl group, and even more preferably a (C₁-C₄) alkyl group, examples of which include, but are not limited to, methyl, ethyl, propyl, butyl. For certain other embodiments, R⁵ can be a halogen, and preferably, Cl, Br, or I. For certain other embodiments, R⁵ can be R⁴ wherein R⁴ is a (C₂-C₁₂) organic group having at least one CN group and having a molecular weight of about 30 to about 200 per CN group.

For certain embodiments, each R⁴ is a (C₂-C₂₀) organic group, more preferably a (C₂-C₁₂) organic group, including at least one CN group and having a molecular weight of about 30 to about 200 per CN group. For certain embodiments, R⁴ includes one or more aromatic groups. Preferably, the molecular weight is about 30 to about 150 per CN group. Examples of CN-containing groups for R⁴ include, but are not limited to, N-methyl-(2-cyanoethyl)carbamido, N-bis(2-cyanoethyl)carbamido, p-(2-cyanoethyl)phenyl, p-(2,2-dicyanopropyl)phenyl, p-(1,2-dicyanopropionitrilo)phenyl, N-methyl-N-(2-cyanoethyl)benzylamino, bis-N-(2-cyanoethyl)benzylamino, cyanomethyl, 2,2′-dicyanopropyl, 1,2,2′-tricyanoethyl, and N,N′-bis(2-cyanoethyl)aminoethyl.

For certain embodiments, R² is independently H, a (C₅-C₈) aryl group, or R⁴ and R⁴ is a (C₂-C₂₀) organic group, more preferably a (C₂-C₁₂) organic group, having at least one CN group and having a molecular weight of about 30 to about 200 per CN group.

In specific embodiments, the invention includes a composition containing a polymer having at least two monomeric units corresponding, respectively, to the formulae: 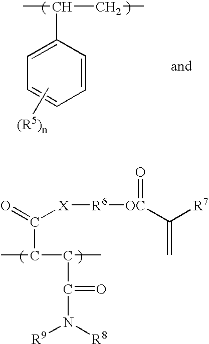
wherein X represents O, S, or NR¹⁰, wherein R¹⁰ represents H or a C₁-C₂ alkyl group; R⁶ represents a C₁-C₅ alkylene group, optionally substituted with at least one hydroxyl group; R⁷ represents H or CH₃; R⁸ represents an C1-C6 alkyl group or an organic group comprising at least one CN group and having a molecular weight of about 30 to about 200 per CN group; and R⁹ represents an organic group comprising at least one CN group and having a molecular weight of about 30 to about 200 per CN group.

In one approach, the present invention provides a polymer having at least two monomeric units corresponding, respectively, to the formulae: 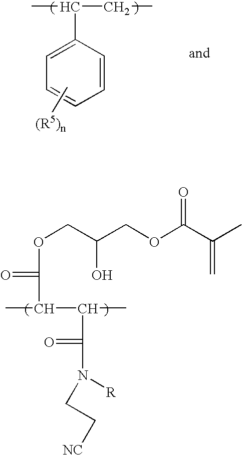
wherein: R is CH₃ or CH₂CH₂CN; each R⁵ is independently an alkyl group, a halogen, or an organic group comprising at least one CN group and having a molecular weight of about 30 to about 200 per CN group; and n=0-3.

Further suitable polymers include those disclosed in U.S. patent application Ser. No. 10/434,377 (Bai et al.), filed on May 8, 2003.

Liquid Delivery Medium

The liquid delivery medium typically comprises at least one of water and/or at least one organic solvent. Exemplary organic solvents include glycols (e.g., mono-, di- or tri-ethylene glycols or higher ethylene glycols, propylene glycol, 1,4-butanediol or ethers of such glycols, thiodiglycol), glycerol and ethers and esters thereof, polyglycerol, mono-, di-, and tri-ethanolamine, propanolamine, N,N-dimethylformamide, dimethylsulfoxide, N,N-dimethylacetamide, N-methylpyrrolidone, 1,3-dimethylimidazolidone, methanol, ethanol, isopropanol, n-propanol, diacetone alcohol, acetone, methyl ethyl ketone, propylene carbonate, and combinations thereof. The printable composition may contain one or more optional additives such as, for example, colorants (e.g., dyes and/or pigments), thixotropes, thickeners, or a combination thereof.

The liquid delivery medium may be present in the printable composition in any amount, typically chosen to achieve the desired viscosity, as discussed herein. Typically, the liquid delivery medium is present in the printable composition in an amount of at least 50 percent up to and including 80 percent by volume, based on the total volume of the printable composition.

Particles

Inkjet printable compositions of the present invention further optionally include a printable particulate material having a high dielectric constant. Specific useful particles with high dielectric constants include ferroelectric ceramic fillers such as barium titanate (BaTiO₃). Other suitable ceramic particles include strontium titanate, lead zirconate or other fillers that have a high dielectric constant such as those disclosed in U.S. Pat. No. 6,159,611 (Lee) and U.S. Pat. No. 6,586,791 (Lee). For example, suitable materials include BaTiO₃, SrTiO₃, Mg₂TiO₄, Bi₂(TiO₃)₃, PbTiO₃, NiTiO₃, CaTiO₃, ZnTiO₃, Zn₂TiO₄, BaSnO₃, Bi(SnO₃)₃, CaSnO₃, PbSnO₃, PbMgNbO₃, MgSnO₃, SrSnO₃, ZnSnO₃, BaZrO₃, CaZrO₃, PbZrO₃, MgZnO₃, SrZrO₃, and ZnZrO₃. Dense polycrystalline ceramics such as barium titanate and lead zirconate are particularly preferred for use in the invention.

The particulate material can be selected for physical, optical, or other properties of interest. For example, in situations where transparency is desirable, it may be preferred to choose inorganic particles that are transparent, have a refractive index that matches the matrix material, and/or are small enough that light scattering is minimized. They may be selected for their lack of absorption of ultraviolet radiation (in certain embodiments).

One advantage of the use of oxide inorganic particles in the printable composition according to the present invention is improvement of the hardness and abrasion resistance of resulting cured coatings. Another advantage is the retention of transparency of cured coatings. Also, suitable selection of an inorganic oxide or oxide mixture allows control of the refractive index properties of printable insulating compositions depending upon the refractive index and concentration of inorganic particles in the dispersion.

In some embodiments of the invention, the particles of the composition comprise nanometer-sized particles, also referred to as inorganic particles, along with the polymer composition. In practice of the present invention, particle size may be determined using any suitable technique.

Typically, when particles are included in the printable composition, they comprise from at least 5 up to and including 60 percent by volume inorganic particles or more, based on the total volume of the polymer and inorganic particles. In some implementations, the quantity of inorganic particles is at least 10 percent by volume, often at least 30 percent by volume inorganic particles, and typically less than or equal to 60 percent by volume, based on the total volume of the polymer and inorganic particles. Surface modification of inorganic particles can be carried out in water or in a mixture of water and one or more co-solvents depending on the particular surface treatment agent used.

In some embodiments, the inorganic particles have an average size of 1 to 500 nanometers, while in others the inorganic particles have an average size of 10 to 250 nanometers, while in yet other embodiments they have an average size of 20 to 80 nanometers, or from 10 to 30 nanometers. Particle size refers to the number average particle size and is measured using an instrument that uses transmission electron microscopy or scanning electron microscopy. Another method to measure particle size is dynamic light scattering, which measures weight average particle size. One example of such an instrument found to be suitable is marketed under the trade designation “N4 PLUS SUB-MICRON PARTICLE ANALYZER” by from Beckman Coulter, Inc. of Fullerton, Calif.

Printing

Compositions of the present invention are printable using digital printing methods, including inkjet printing. Exemplary inkjet printing methods include thermal inkjet, continuous inkjet, piezo inkjet, acoustic inkjet, and hot melt inkjet printing. Thermal inkjet printers and/or print heads are readily commercially available, for example, from Hewlett-Packard Company (Palo Alto, Calif.), and Lexmark International (Lexington, Ky.). Continuous inkjet print heads are commercially available, for example, from continuous printer manufacturers such as Domino Printing Sciences (Cambridge, United Kingdom). Piezo inkjet print heads are commercially available, for example, from Trident International (Brookfield, Conn.), Epson (Torrance, Calif.), Hitachi Data Systems Corporation (Santa Clara, Calif.), Xaar PLC (Cambridge, United Kingdom), Spectra (Lebanon, N.H.), and Idanit Technologies, Limited (Rishon Le Zion, Israel). Hot melt inkjet printers are commercially available, for example, from Xerox Corporation (Stamford, Conn.).

Inkjet printing is highly versatile in that printing patterns can be easily changed, whereas screen printing and other tool-based techniques require a different screen or tool to be used with each individual pattern. Thus, inkjet printing does not require a large inventory of screens or tools that need to be cleaned and maintained. Also, additional printable compositions can be inkjet printed onto previously formed insulating layers to create larger (e.g., taller) layers and/or build electronic devices.

Thus, the printable composition has a viscosity making it amenable to inkjet printing onto a substrate. Typically, the composition has a viscosity of 1 to 40 millipascal-seconds measured the print head temperature using continuous stress sweep over shear rates of 1 second⁻¹ to 1000 second⁻¹, and frequently a viscosity of 6 to 20 millipascal-seconds measured at the print head temperature using continuous stress sweep, over shear rates of 1 second⁻¹ to 1000 second⁻¹. Useful print head temperatures include, for example, those less than or equal to 60° C., although higher temperatures may also be used.

Inkjet printing of the composition can provide many advantages over conventional methods of applying insulating layers to a substrate. The present invention allows for the dielectric layer to be precisely deposited without potentially damaging or contaminating the substrate. Inkjet printing is a non-contact printing method, thus allowing insulating materials to be printed directly onto substrates without damaging and/or contaminating the substrate surface due to contact, as may occur when using screens or tools and/or wet processing during conventional patterning. Inkjet printing also provides a highly controllable printing method that can produce precise and consistently applied material.

Additional Ingredients and Post-Printing Processing

Also, if desired, the polymers of the present invention can be mixed with a photoinitiator to enhance crosslinking. Useful photoinitiators that initiate free radical polymerization are described, for example, in Chapter II of “Photochemistry” by Calvert and Pitts, John Wiley & Sons (1966). Examples of these photoinitiators include acryloin and derivatives, thereof, such as benzoin, benzoin methyl ether, benzoin ethyl ether, benzoin isopropyl ether, benzoin isobutyl ether, and (alpha)-methylbenzoin; diketones such as benzil and diacetyl, etc.; organic sulfides such as diphenyl monosulfide, diphenyl disulfide, decyl phenyl sulfide, and tetramethylthiuram monosulfide; S-acyl thiocarbamates such as S-benzoyl-N,N-dimethyldithiocarbamate; and phenones such as acetophenone, benzophenone, and derivatives thereof.

After printing the polymers of the present invention can be crosslinked using radiation (e.g., ultraviolet (UV), e-beam, gamma) or thermal energy, for example. Chemical crosslinking agents can also be used if desired. Examples include, but are not limited to, 1,6-hexanediol di(meth)acrylate, 1,4-butanediol di(meth)acrylate, ethylene di(meth)acrylate, glyceryl di(meth)acrylate, glyceryl tri(meth)acrylate, diallyl phthalate, pentaerythritol triacrylate, dipentaerythritol pentaacrylate, neopentyl glycol triacrylate and 1,3,5-tri(2-methacryloxyethyl)-s-triazine.

The printable composition is normally hardened after printing, for example by curing via radiation exposure, heat exposure, and the like. In many cases, it may be desirable to set the position and shape of the inkjet printed insulating material by cooling the insulating material from a less viscous state for printing to a more viscous state that maintains a size and shape.

The articles formed using the methods and materials of the invention can be used to form various electronic devices. Examples include transistors, diodes, capacitors (e.g., embedded capacitors), and resistors, which can be used in various arrays to form amplifiers, receivers, transmitters, inverters, and oscillators.

Objects and advantages of this invention are further illustrated by the following examples, but the particular materials and amounts thereof recited in these examples, as well as other conditions and details, should not be construed to unduly limit this invention.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents were obtained from Aldrich Chemical, Milwaukee, Wis. unless otherwise specified.

TABLE OF ABBREVIATIONS

| Abbreviation | Description |
|---|---|
| Polymer 1 | Prepared according to the method described below. |
| BT Ceramic | BaTiO₃ ceramic dispersions prepared using the method |
| Dispersions | described below. |
| PS3 | a dispersant containing polyamine/polyester, purchased |
| | from Uniqema, Wilmington, Delaware. |
| MEK | methyl ethyl ketone |
| MIBK | methyl isobutyl ketone |
| SMA | a 1:1 alternating copolymer of styrene and maleic anhydride |
| | obtained under the trade designation “SMA PRO5542 |
| | RESIN” from Sartomer Company, Exton, Pennsylvania |
| DMAc | N,N-dimethylacetamide, anhydrous |
| DMAP | N,N-dimethylaminopyridine |
| GMA | glycidyl methacrylate |

Preparation of Polymer 1

To a 250-ml, three-necked flask fitted with magnetic stirrer and nitrogen inlet were charged 3,3′-iminodipropionitrile (36.50 g, 90 percent) and a solution of SMA (45.00 g) dissolved in DMAc (80 ml). After the mixture was stirred for 30 minutes at room temperature, N,N-dimethylaminopyridine (DMAP) (0.50 g, 99 percent) was added to the solution and the solution was then heated at 120° C. for 24 hours. The solution was allowed to cool to room temperature and was slowly poured into 1.5 liters of isopropanol while stirred mechanically. The yellow precipitate that formed was collected by filtration and dried at 100° C. for 48 hours at reduced pressure (˜30 mm Hg). Yield: 68.6 g.

To a stirred solution of above prepared material (40.00 g) dissolved in DMAc (100 ml) were placed 56.00 g GMA, 0.20 g hydroquinone, and 1.0 g N,N-dimethylbenzylamine. The mixture was flushed with nitrogen, and then heated at 55° C. for 20 hours. After the solution was allowed to cool to room temperature, it was poured slowly into 1.5 liters of a mixture of hexane and isopropanol (2:1, volume/volume) with mechanical stirring. The precipitate that formed was dissolved in 50 ml of acetone and precipitated twice, first into the same solvent mixture as used above and then into isopropanol. The resultant brown power-like solid was collected by filtration and dried at 50° C. for 24 hours under reduced pressure (˜30 mm Hg). Yield: 32.2 g.

Preparation of BT Ceramic Dispersions

BT Ceramic Dispersions were prepared by mixing BaTiO₃ powder with a mixed solvent of MEK/MIBK using PS3 as dispersant. The percentage by weight of BaTiO₃ powder in the resulting dispersion was 70 percent.

Test Methods

Rheology Measurement

Rheology was measured on a BOHLIN C-VOR RHEOMETER obtained from Bohlin Instruments Limited, Cirencester, Gloucestershire, England, using a C25 cup and bob geometry, continuous stress sweep mode, from 1 second⁻¹ to 10000 second⁻¹. Results are reported as whether the fluid was Newtonian or not and the viscosity was measured in millipascal-seconds.

Surface Tension Measurement

Surface tension was measured using a Kruss surface tensiometer commercially available from Kruss USA, Charlotte, N.C., according to the Wilhemy plate method. Results were measured in dynes per centimeter and converted to Newtons per meter.

Thickness Measurement

Thickness was measured using a VEECO DEKTAK 6M STYLUS PROFILER commercially available from Veeco Instruments, Woodbury, N.Y. Results are reported in micrometers.

Capacitance Measurement

The capacitance was measured using an HP4192A LF IMPEDANCE ANALYZER commercially available from Hewlett Packard Company, Palo Alto, Calif. Results are reported in capacitance/unit area (picoFarads per square millimeter/mm²).

Dielectric Constant Determination

Dielectric constants were calculated using the following equation: C/A=εεₒ/d, where C=Capacitance; εₒ=Permittivity of free space=8.854×10⁻¹⁵ Farads/millimeter; ε=Dielectric constant; A=Area of the capacitor=the area of the top small gold dot; and d=Thickness of the organic insulating film.

### Example 1

Preparation of Polymer/BaTiO₃ Dispersion Ink:

A solution of the following components was first prepared and filtered through a 0.45 micrometer filter: 1.73 grams of Polymer 1, 17.30 grams of cyclopentanone, 0.20 grams of pentaerythritol triacrylate, and 17 milligrams of benzoyl peroxide. To this filtered solution, 15.89 grams of BT Ceramic Dispersion was added to give a BaTiO₃ loading of 50 percent by volume, based on solids. The whole mixture was sonicated for 5 minutes and well-shaken before being used.

Rheology and Surface Tension Measurement:

The rheology and surface tension of the mixture prepared above was measured as described in the test methods above. The mixture was a Newtonian fluid with a viscosity of 6 millipascal seconds, and a surface tension of 0.0294 Newtons/meter.

Inkjet Printing Process:

The ink was printed using a Xaar XJ128-200 piezo print head mounted on an XY translational stage at 317×295 dots per inch (dpi) resolution. The print head was driven at 1250 Hz and 35 Volts. Samples were printed onto cleaned silicon wafers, in a simple 1-inch (2.5 cm) square pattern. Samples were printed with a range of passes on the printer, from a single pass up to three passes. The coatings were thermally cured on a hot plate with temperature set around 175° C. in a nitrogen environment for 30 minutes. The surface of the sample printed with a single pass was very smooth, while the surface of the samples printed with multiple passes were rough. By optical micrograph, the sample printed with a single pass exhibited pinholes, while the samples printed with 2 or 3 passes did not.

### Example 2-3 and Comparative Example C

Preparation of Polymer/BaTiO₃ Dispersion Ink:

The procedure described in Example 1 was followed.

Formation of Capacitors:

The Polymer/BaTiO₃ Dispersion Ink prepared above was used to form capacitors in order to find out the dielectric constant of the cured films. A tantalum coated n⁺Si/Al was used as the substrate and the Polymer/BaTiO₃ Dispersion Ink was inkjet printed on it with two passes (Example 2) or three passes (Example 3) or spin coated (Comparative Example C). Thermal cure on a hot plate with temperature set around 175° C. in a nitrogen environment for 30 minutes was used to completely cure these films. Gold dot arrays (about 90 nm thick with a diameter of 2 mm) were deposited and patterned through a metal shadow tool in a vacuum chamber.

Thickness and Capacitance Measurement:

The thickness and capacitance of the samples were measured using the test methods described above and these values were used to calculate the dielectric constant. The thickness, capacitance and calculated dielectric constants are shown in Table 1 (below).

TABLE 1

| | | Average Film | Average | |
|---|---|---|---|---|
| | Coating | Thickness | capacitance/unit | Dielectric |
| Example | Description | (micrometers) | area (pF/mm²) | Constant |
| 2 | Inkjet | 4.13 ± 0.8 | 77.33 | 36.1 |
| | Printed, 2 | | | |
| | passes | | | |
| 3 | Inkjet | 6.94 ± 1.2 | 45.04 | 35.3 |
| | Printed, 3 | | | |
| | passes | | | |
| C | Spin | 0.97 ± 0.02 | 36.63 | 4.01 |
| | Coated | | | |

All patents, patent applications, and publications cited herein are incorporated by reference in their entirety as if individually incorporated. Various modifications and alterations of this invention will be apparent to those skilled in the art in view of the foregoing description, without departing from the scope and principles of this invention. Accordingly, it should be understood that this invention is not to be unduly limited to the illustrative embodiments set forth hereinabove.

1. A printable composition for forming a dielectric layer, the composition comprising a polymer having at least two monomeric units corresponding, respectively, to the formulae: 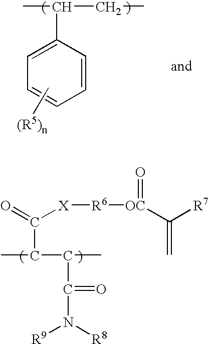
wherein X represents O, S, or NR¹⁰, wherein R¹⁰ represents H or a C₁-C₂ alkyl group; R⁶ represents a C₁-C₅ alkylene group, optionally substituted with at least one hydroxyl group; R⁷ represents H or CH₃; R⁸ represents an C₁-C₆ alkyl group or an organic group comprising at least one CN group and having a molecular weight of about 30 to about 200 per CN group; and R⁹ represents an organic group comprising at least one CN group and having a molecular weight of about 30 to about 200 per CN group; and
from 5 to 60 percent by volume inorganic particles, based on the total volume of polymer and inorganic particles; and
a liquid delivery medium;
wherein the composition has a viscosity of 1 to 40 millipascal-seconds measured using continuous stress sweep, over shear rates of 1 second⁻¹ to 1000 second⁻¹ at at least one temperature less than or equal to 60° C.

2. The printable composition for forming a dielectric layer of claim 1, wherein the composition is suitable for inkjet printing.

3. The printable composition for forming a dielectric layer of claim 1, wherein the inorganic particles comprise barium titanate.

4. The printable composition of claim 1, wherein the composition is curable and after curing has a dielectric constant greater than 20.

5. The printable composition of claim 1, wherein the composition is curable and after curing has a dielectric constant greater than 40.

6. A composition for forming a dielectric layer, the composition comprising:
from 5 to 95 percent by weight of a polymer, based on the total weight of polymer and inorganic particles, comprising at least two monomeric units corresponding, respectively, to the formulae: 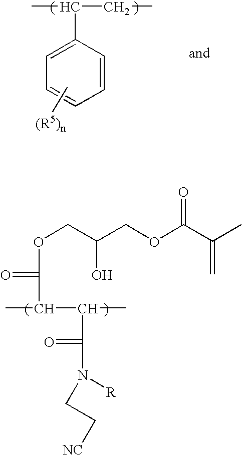
wherein R is CH₃ or CH₂CH₂CN; each R⁵ is independently an alkyl group, a halogen, or an organic group comprising at least one CN group and having a molecular weight of about 30 to about 200 per CN group; and n=0-3;
and from 5 to 60 percent by volume inorganic particles, based on the total volume of the polymer and inorganic particles; and
a liquid delivery medium;
wherein the composition has a viscosity of 1 to 40 millipascal-seconds measured using continuous stress sweep, over shear rates of 1 second⁻¹ to 1000 second⁻¹ at at least one temperature less than or equal to 60° C.

7. The composition for forming a dielectric layer of claim 6, wherein the composition is suitable for inkjet printing.

8. The composition for forming a dielectric layer of claim 6, wherein the inorganic particles comprise barium titanate.

9. The composition of claim 6, wherein the composition after curing has a dielectric constant greater than 20.

10. The composition of claim 6, wherein the composition after curing has a dielectric constant greater than 40.

11. The composition of claim 6, wherein the composition comprises:
from 10 to 95 percent by weight polymer, based on the total weight of the polymer and inorganic particles; and
from 5 to 60 percent by volume inorganic particles, based on the total volume of the polymer and inorganic particles.

12. The composition of claim 6, wherein the composition has a viscosity of 6 to 20 millipascal-seconds measured using continuous stress sweep, over shear rates of 1 second⁻¹ to 1000 second⁻¹ at at least one temperature less than or equal to 60° C.

13. The composition of claim 7, wherein the particles comprise barium titanate.

14. A method of forming a dielectric film, the method comprising:
providing a printable composition for forming a dielectric layer, the composition comprising a polymer having at least two monomeric units corresponding, respectively, to the formulae: 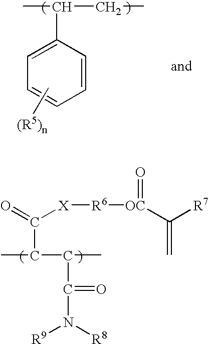
wherein X represents O, S, or NR¹⁰, wherein R¹⁰ represents H or a C₁-C₂ alkyl group; R⁶ represents a C₁-C₅ alkylene group, optionally substituted with at least one hydroxyl group; R⁷ represents H or CH₃; R⁸ represents an C₁-C₆ alkyl group or an organic group comprising at least one CN group and having a molecular weight of about 30 to about 200 per CN group; and R⁹ represents an organic group comprising at least one CN group and having a molecular weight of about 30 to about 200 per CN group; and
from 5 to 60 percent by volume inorganic particles, based on the total volume of polymer and inorganic particles; and
a liquid delivery medium;
wherein the composition has a viscosity of 1 to 40 millipascal-seconds measured using continuous stress sweep, over shear rates of 1 second⁻¹ to 1000 second⁻¹ at at least one temperature less than or equal to 60° C.

15. A method of forming a dielectric film, the method comprising:
providing a printable composition containing from 50 to 95 percent by weight of a polymer comprising at least two monomeric units corresponding, respectively, to the formulae: 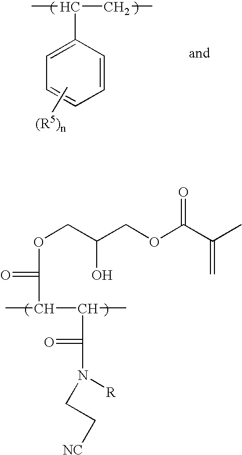
wherein R is CH₃ or CH₂CH₂CN; each R⁵ is independently an alkyl group, a halogen, or an organic group comprising at least one CN group and having a molecular weight of about 30 to about 200 per CN group; and n=0-3; and from 5 to 60 percent by volume inorganic particles, based on the total volume of the polymer and inorganic particles; and a liquid delivery medium; wherein the composition has a viscosity of 1 to 40 millipascal-seconds measured using continuous stress sweep, over shear rates of 1 second⁻¹ to 1000 second⁻¹ at at least one temperature less than or equal to 60° C.; and
digitally depositing the composition onto a substrate.

15. The method of claim 14, wherein the printable composition is suitable for inkjet printing.

16. The method of claim 14, wherein the inorganic particles comprise barium titanate.

17. The method of claim 14, wherein the composition after curing has a dielectric constant greater than 20.

18. The method of claim 14, wherein the composition after curing has a dielectric constant greater than 40.

19. An electronic device comprising a dielectric film formed according to the method of claim 14.

20. A method of forming a dielectric film, the method comprising:
providing a printable composition containing from 50 to 95 percent by weight of a polymer comprising at least two monomeric units corresponding, respectively, to the formulae: 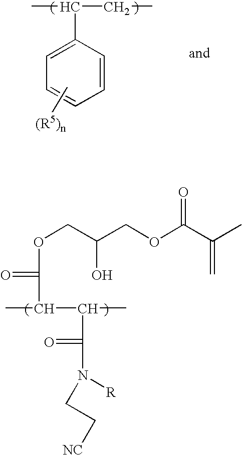
wherein R is CH₃ or CH₂CH₂CN; each R⁵ is independently an alkyl group, a. halogen, or an organic group comprising at least one CN group and having a molecular weight of about 30 to about 200 per CN group; and n=0-3; and a liquid delivery medium; wherein the composition has a viscosity of 1 to 40 millipascal-seconds measured using continuous stress sweep, over shear rates of 1 second⁻¹ to 1000 second⁻¹ at at least one temperature less than or equal to 60° C.; and
digitally depositing the composition onto a substrate.
